(19) United States
(12) Patent Application Publication
(10) Pub. No.: US 2011/0044303 A1
(43) Pub. Date: Feb. 24, 2011

(54) DEVICE, SYSTEM, AND METHOD OF ADJUSTING A CONTENTION WINDOW FOR WIRELESS TRANSMISSION

(76) Inventors: Xuquan Ji, Shanghai (CN); Guoqing Li, Portland, OR (US); Lei Shen, Shanghai (CN)

Correspondence Address: Shiloh et al., C/O INTELLEVATE , LLC, P.O BOX 52050, MINNEAPOLIS, MN, 55402, US

(21) Appl. No.: 12/542,741

(22) Filed: Aug. 18, 2009

(51) Int. Cl. H04W 4/00; H04L 12/43

(52) U.S. Cl. 370/338; 370/461

(57) ABSTRACT

Device, system, and method of adjusting a contention window for wireless transmission. In some embodiments, a wireless communication unit may control transmissions of a wireless communication device in a wireless area network during a contention period, wherein the wireless communication unit is to select a back-off period within a contention-window having a contention-window size, which is adjusted based on a number of stations included in the wireless area network, and wherein the wireless communication unit is to wait for the back-off period prior to beginning a wireless transmission during the contention period. Other embodiments are described and claimed.

### BACKGROUND

In a wireless communication system or network, devices may transmit over a wireless channel only after sensing that the channel is not in use (“clear” or “idle”). However, if the devices try to transmit immediately after sensing that the channel is not currently in use, all the devices that were waiting for a clear channel may try to transmit at the same time immediately after the channel ceases to be busy. The resulting “collision” between the signals can prevent one or more of the devices from making a successful transmission.

To reduce the chance of such collisions, some wireless communication standards define a “Contention Window” (CW) scheme including a contention period, during which devices that want to transmit will wait, after sensing an open channel, before actually performing a transmission. According to this contention-based scheme, each device may choose a time period (“the back-off period”), e.g., randomly, and wait until the channel has been idle for this time period before trying to transmit (“first transmission attempt”). The CW defines the maximum period that the device should wait, e.g., the random values are chosen to be within the CW. If the resulting first transmission attempt is unsuccessful, the length of the contention window can be repeatedly increased for subsequent retries, up to some maximum value, until a retry is successful, or until a maximal number of retransmissions is reached. The CW period may be defined by a first value, denoted CWmin, which defines a minimum starting size of the CW, and a second value, denoted CWmax, which defines the maximal size of the CW.

The WirelessHD™ specification defines a wireless protocol that enables consumer devices to create a Wireless Video Area Network (WVAN) for high quality video transmission using the 60 GHz frequency band. The WirelessHD™ specification defines a contention period, termed Random Access Time Block (RATB), during which stations of the WVAN may use a Preamble Sense Multiple Access with Collision Avoidance (PSMA/CA) contention-based scheme to access the wireless medium. The RATB may be used, for example, for exchanging control messages, e.g., Beamforming requests, channel time requests, audio data transmission, and the like. Most of the traffic transmitted during the RATB is very sensitive to latency, which may impact user experience significantly.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system in accordance with some demonstrative embodiments.

FIG. 2 is a schematic illustration of a Random Access Time Block (RATB) allocation information element, in accordance with some demonstrative embodiments.

FIG. 3 is a schematic flow-chart illustration of a method of wireless communication, in accordance with some demonstrative embodiments.

FIG. 4 is a schematic illustration of first and second graphs depicting a collision probability as a function of a number of stations in a wireless area network, when using constant contention window size and a dynamic contention window size, respectively, in accordance with some demonstrative embodiments.

FIG. 5 is a schematic illustration of an article of manufacture, in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality” as used herein include, for example, “multiple” or “two or more”. For example, “a plurality of items” includes two or more items.

Some embodiments may be used in conjunction with various devices and systems, for example, a video device, an audio device, an audio-video (A/V) device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a data source, a data sink, a Digital Still camera (DSC), a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a wired or wireless network, a wireless area network, a Wireless Video Are Network (WVAN), a Local Area Network (LAN), a Wireless LAN (WLAN), a Personal Area Network (PAN), a Wireless PAN (WPAN), devices and/or networks operating in accordance with existing WirelessHD™ and/or Wireless-Gigabit-Alliance (WGA) specifications and/or future versions and/or derivatives thereof, devices and/or networks operating in accordance with existing IEEE 802.11 (IEEE 802.11-1999: Wireless LAN Medium Access Control (MAC) and Physical Layer (PHY) Specifications), 802.11a, 802.11b, 802.11g, 802.11h, 802.11j, 802.11n, 802.16, 802.16d, 802.16e, 802.16f, standards and/or future versions and/or derivatives thereof, units and/or devices which are part of the above networks, one way and/or two-way radio communication systems, cellular radio-telephone communication systems, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device (e.g., BlackBerry, Palm Treo), a Wireless Application Protocol (WAP) device, or the like.

Some embodiments may be used in conjunction with one or more types of wireless communication signals and/or systems, for example, Radio Frequency (RF), Infra Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, Enhanced Data rates for GSM Evolution (EDGE), or the like. Other embodiments may be used in various other devices, systems and/or networks.

The term “wireless device” as used herein includes, for example, a device capable of wireless communication, a communication device capable of wireless communication, a communication station capable of wireless communication, a portable or non-portable device capable of wireless communication, or the like. In some embodiments, a wireless device may be or may include a peripheral that is integrated with a computer, or a peripheral that is attached to a computer. In some embodiments, the term “wireless device” may optionally include a wireless service.

Some demonstrative embodiments may be used in conjunction with suitable limited-range or short-range wireless communication networks, for example, “piconets”, e.g., a wireless area network, a WVAN, a WPAN, and the like.

Some embodiments may be implemented for wireless transmission of suitable content between two or more devices. In one embodiment, the content may include media content, for example, audio and/or video content, e.g., High Definition Television (HDTV) content, and the like. In other embodiments, the content may include any other suitable data, information and/or signals.

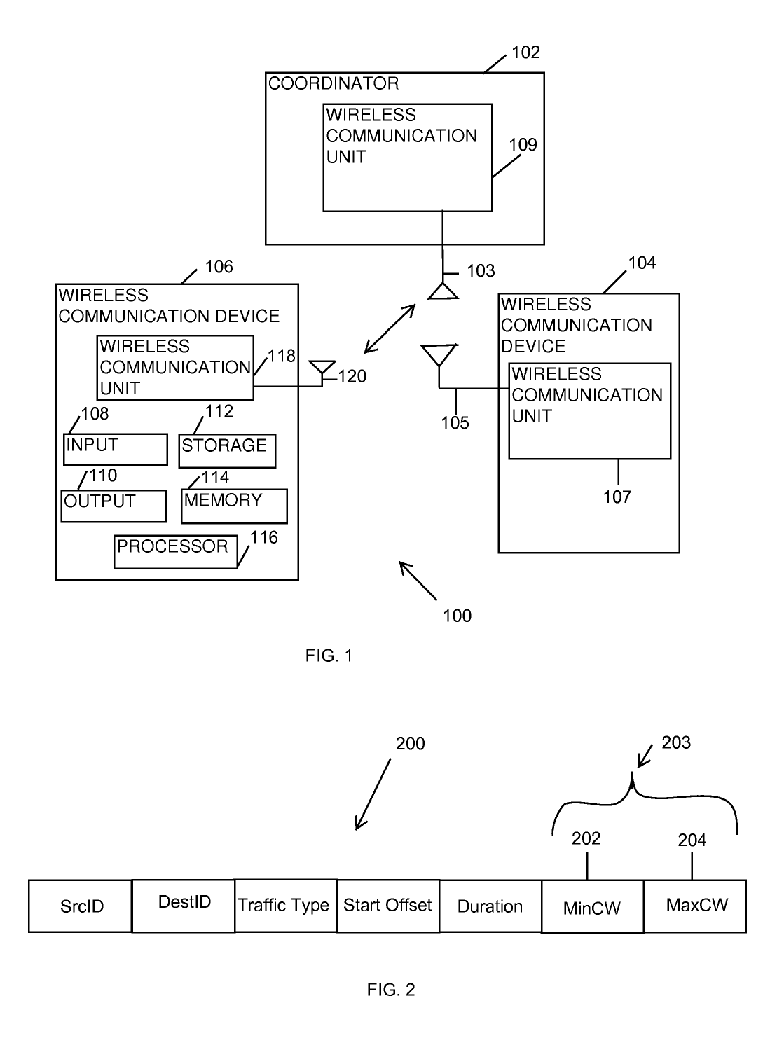

Reference is now made to FIG. 1, which schematically illustrates a block diagram of a system 100 in accordance with some demonstrative embodiments. System 100 may operate as a wireless area network including a plurality of communication nodes (“nodes”). Each node of system 100 may include any suitable physical and/or logical entity capable of communicating information in system 100, and may be implemented using any suitable hardware and/or software.

In some demonstrative embodiments, one or more nodes of system 100 may be capable of communicating content over one or more suitable wireless communication links, for example, a radio channel, an IR channel, a RF channel, a Wireless Fidelity (WiFi) channel, and the like. One or more nodes of system 100 may optionally be capable of communicating over any suitable wired communication links.

In some demonstrative embodiments, system 100 may be implemented in accordance with the WirelessHD™ specification, the Wireless-Gigabit-Alliance (WGA) specification, and the like. For example, system 100 may perform the functionality of a WVAN. In other embodiments, system 100 may be implemented in accordance with any other suitable standard, protocol or specification, for example, standards, protocols and/or specifications promoted by the International Telecommunications Union (ITU), the International Organization for Standardization (ISO), the International Electrotechnical Commission (IEC), the Institute of Electrical and Electronics Engineers (information IEEE), the Internet Engineering Task Force (IETF), and the like.

Although some demonstrative embodiments are described herein with reference to a WVAN, other embodiments may be implemented with any other suitable wireless network and/or protocol, for example, a WPAN, a Wireless Metropolitan Area Network (WMAN), a Wireless Wide Area Network (WWAN), a Broadband Wireless Access (BWA) network, a radio network, a television network, a satellite network, a direct broadcast satellite (DBS) network, and the like.

In some demonstrative embodiments, system 100 may communicate, manage and/or process information in accordance with one or more suitable communication protocols. For example, system 100 may implement one or more of a medium access control (MAC) protocol, a Physical Layer Convergence Protocol (PLCP), a Simple Network Management Protocol (SNMP), an Asynchronous Transfer Mode (ATM) protocol, a Frame Relay protocol, a Systems Network Architecture (SNA) protocol, a Transport Control Protocol (TCP), an Internet Protocol (IP), a Hypertext Transfer Protocol (HTTP), a User Datagram Protocol (UDP), and the like.

As shown in FIG. 1, in some embodiments, system 100 may include a coordinator 102 and one or more wireless communication devices (“stations”), e.g., devices 104 and/or 106.

In some demonstrative embodiments, coordinator 102 may be capable of coordinating communications over the wireless area network. For example, coordinator 102 may control timing in system 100, keep track of members of the wireless area network and/or perform any other suitable functionality, e.g., as defined by the WirelessHD™ specification. In one example, coordinator 102 may include a video and/or audio sink device, e.g., a display, a media storage device, and the like. In some embodiments coordinator 102 may include or may perform the functionality of a station, e.g., in addition to the coordinator functionality.

In some demonstrative embodiments, wireless communication devices 106 and/or 104 may include, for example, a video device, an audio device, an A/V device, a STB, a BD player, a BD recorder, a DVD player, a HD DVD player, a DVD recorder, a HD DVD recorder, a PVR, a broadcast HD receiver, a video source, an audio source, a video sink, an audio sink, a stereo tuner, a broadcast radio receiver, a flat panel display, a PMP, a DVC, a digital audio player, a speaker, an audio receiver, an audio amplifier, a data source, a data sink, a DSC, a media player, a Smartphone, a television, a music player, a PC, a desktop computer, a mobile computer, a laptop computer, a notebook computer, a tablet computer, a server computer, a handheld computer, a handheld device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, or the like.

In some demonstrative embodiments, wireless device 106 may include a wireless communication unit 118, wireless communication device 104 may include a wireless communication unit 107 and/or coordinator 102 may include a wireless communication unit 109.

In some demonstrative embodiments, coordinator 102, device 104 and/or device 106 may include, for example, one or more of a processor 116, an input unit 108, an output unit 110, a memory unit 114, and a storage unit 112. Coordinator 102, device 104 and/or device 106 may optionally include other suitable hardware components and/or software components. In some embodiments, some or all of the components of each of coordinator 102, device 104, device 106 may be enclosed in a common housing or packaging, and may be interconnected or operably associated using one or more wired or wireless links. In other embodiments, components of coordinator 102, device 104 and/or device 106 may be distributed among multiple or separate devices or locations.

Processor 116 includes, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 116 executes instructions, for example, of an Operating System (OS) of coordinator 102, device 104 and/or device 106; and/or of one or more suitable applications.

Input unit 108 includes, for example, a keyboard, a keypad, a mouse, a touch-pad, a track-ball, a stylus, a microphone, or other suitable pointing device or input device. Output unit 110 includes, for example, a monitor, a screen, a Cathode Ray Tube (CRT) display unit, a Liquid Crystal Display (LCD) display unit, a plasma display unit, one or more audio speakers or earphones, or other suitable output devices.

Memory unit 114 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 112 includes, for example, a hard disk drive, a floppy disk drive, a Compact Disk (CD) drive, a CD-ROM drive, a DVD drive, or other suitable removable or non-removable storage units. Memory unit 114 and/or storage unit 112, for example, store data processed by coordinator 102, device 104 and/or device 106.

Wireless communication units 118, 109 and/or 107 include, for example, one or more wireless transmitters, receivers and/or transceivers able to send and/or receive wireless communication signals, RF signals, frames, blocks, transmission streams, packets, messages, data items, and/or data. For example, communication units 118, 109 and/or 107 may include or may be implemented as part of a wireless Network Interface Card (NIC), and the like.

Wireless communication units 118, 109 and/or 107 may include, or may be associated with, one or more antennas or one or more sets of antennas 120, 103 and/or 105, respectively. Antennas 120, 103 and/or 105 may include, for example, an internal and/or external RF antenna, a dipole antenna, a monopole antenna, an omni-directional antenna, an end fed antenna, a circularly polarized antenna, a micro-strip antenna, a diversity antenna, or other type of antenna suitable for transmitting and/or receiving wireless communication signals, blocks, frames, transmission streams, packets, messages and/or data.

In some demonstrative embodiments, coordinator 102, device 104 and/or device 106 may communicate according to the WirelessHD™ specification. For example, the wireless area network of system 100 may include a WVAN for high quality video transmission using the 60 GHz frequency band. The WirelessHD™ specification defines a contention period, termed Random Access Time Block (RATB), during which stations of the WVAN may use a Preamble Sense Multiple Access with Collision Avoidance (PSMA/CA) contention-based scheme to access the wireless medium. The RATB may be used, for example, for exchanging control messages, e.g., beamforming requests, channel time requests, audio data transmission, and the like. Most of the traffic transmitted during the RATB may be very sensitive to latency, which may impact user experience significantly.

In some demonstrative embodiments, the RATB may be relatively short. For example, the RATB period may last approximately 300 microseconds, which may be allocated, for example, to 27 transmission slots of approximately 11 microseconds each. Accordingly, the RATB period may not be capable of accommodating a large number of “retries” resulting from unsuccessful transmissions.

In some demonstrative embodiments, implementing a shorter contention window (CW) during the RATB may result in a higher collision probability. The presence of a larger number of wireless communication devices in the wireless area network may result in a higher collision probability. For example, using a CW having a size of four slots (“a 4-slot CW”) may result in collision between first transmission attempts by the devices of the wireless area network (“the first-transmission collision”) at a probability of (4!/3!*¼*¼)=¼, e.g., if the wireless area network includes only two stations (“competing stations”). However, the 4-slot CW may result in an increased first-transmission collision probability of (3!/2!*¼*¼)*4=¾, e.g., if the wireless area network includes three stations. The first-transmission collision probability may increase even more, if the wireless area network includes more than three stations. Accordingly, when the wireless area network of system 100 includes three or more wireless communication devices, there may be a relatively high probability of failure for a first attempt by a device, e.g., device 106, to transmit during the RATB. Due to the high collision probability, the device may perform a relatively large number of transmission retries before performing a successful transmission.

The collision probability may be reduced by defining a larger initial contention window. However, such solution may not be scalable. For example, defining a relatively large CW, may result in a “waste” of “channel time” and may reduce the number of retries allowed during the RATB, e.g., if the wireless area network includes only a small number of stations.

In some demonstrative embodiments, coordinator 102, device 104 and/or device 106 may be capable of dynamically adjusting the size of the initial CW window based on the current number of stations in the wireless area network. For example, coordinator 102, device 104 and/or device 106 may be capable of increasing the size of the CW, as one or more stations join or associate the WVAN of system 100, and reduce the size of the CW, as one or more stations leave the WVAN of system 100, as described in detail below.

In some demonstrative embodiments, wireless communication unit 118 may control transmissions of wireless communication device 106 in the wireless area network during a contention period, e.g., the RATB period. For example, wireless communication unit 118 may select a back-off period within a CW having a CW size, which is adjusted based on a number of stations included in the WVAN of system 100, and waiting for the back-off period prior to beginning a wireless transmission during the contention period, as described below.

In some demonstrative embodiments, coordinator 102, device 104 and/or device 106 may adjust the contention window to include a number of slots equal to the number of stations in the wireless area network. For example, wireless communication unit 118 may adjust the CW to include four slots if the WVAN includes four stations, five slots if the WVAN includes five stations, and so on. In other embodiments, the CW may be adjusted using any other suitable scheme, which is based on the number of stations in the WVAN.

In some demonstrative embodiments, coordinator 102, device 104 and/or device 106 may increase the size of the contention window as the number of stations in the wireless area network increases. For example, wireless communication unit 118 may select the back-off period from a contention window of a first size, e.g., four slots, when the wireless area network includes a first number of stations, e.g., four stations; and to select the back-off period from a contention window of a second size, which is greater than the first size, e.g., six slots, when the wireless area network includes a second number of stations, which is greater than the first number, e.g., six stations.

In some demonstrative embodiments, device 104 and/or device 106 may be capable of dynamically adjusting the size of the initial CW window in an implicit and/or independent manner, e.g., based on information indicating the number of stations in the wireless area network of system 100, for example, without receiving the size of the CW and/or an instruction to adjust the size of the CW from another device of system 100. The implicit adjustment of the CW size may enable adjusting the CW size without, for example, affecting the operation of other devices of system 100.

In some demonstrative embodiments, wireless communication unit 118 may determine the number of stations included in the wireless area network based on information received from one or more other elements of system 100, and set the contention window size based on the number of stations included in the wireless area network.

For example, wireless communication unit 118 may receive from coordinator 102 a beacon frame, e.g., a beacon frame broadcasted by coordinator 102 in accordance with the WirelessHD™ specification. The beacon frame may include station-specific Information Elements (IEs) including information relating to the current stations in the wireless area network, e.g., as defined by the WirelessHD™ specification. In one embodiment, wireless communication unit 118 may determine the number of stations included in the wireless area network by counting a number of station-specific IEs included in the beacon frame. For example, if a station joins or associates the WVAN, then coordinator 102 may broadcast a beacon frame including an IE corresponding to the additional station. Upon receiving the beacon frame, wireless communication unit 118 may adjust the CW size, e.g., by increasing the CW size. Similarly, if a station departs the WVAN, then coordinator 102 may broadcast a beacon frame, which includes a reduced number of IEs, e.g., since the beacon frame does not include an IE corresponding to the departed station. Upon receiving the beacon frame, wireless communication unit 118 may adjust the CW size, e.g., by decreasing the CW size.

In some demonstrative embodiments, device 104 and/or device 106 may be capable of dynamically adjusting the size of the initial CW window in an explicit and/or dependent manner, e.g., such that coordinator 102 may set the CW size to be used by devices 104 and/or 106, e.g., as described below.

In some demonstrative embodiments, coordinator 102 may coordinate communication between devices 104 and 106 in network 100 by transmitting a beacon frame including contention-window information, which defines a contention window size to be used by devices 104 and 106 during the contention period, e.g., during the RATB. Coordinator 102 may adjust the contention window size based on the number of stations in the wireless area network. Wireless communication unit 118 may receive the contention-window information, and set the CW size according to the contention-window information.

Reference is also made to FIG. 2, which schematically illustrates a RATB allocation information element 200, in accordance with some demonstrative embodiments. In one embodiment, IE 200 may be transmitted, for example, by coordinator 102 (FIG. 1), e.g., as part of a beacon frame.

As shown in FIG. 2, in some demonstrative embodiments, IE 200 may include one or more fields defining an allocation of the RATB period. For example, IE 200 may include a source ID field, a destination ID field, a traffic type field, a start offset field and a duration field, e.g., in accordance with the WirelessHD™ specification.

In some demonstrative embodiments, IE 200 may include CW information 203 defining a CW size to be used during the RATB period. For example, CW information 203 may include a first value 202, denoted CWmin, which defines a minimum starting size of the CW, e.g., to be used for a first transmission attempt during the RATB period; and a second value 204, denoted CWmax, which defines a maximal size of the CW, to which the CW may be increased during one or more retries.

In some demonstrative embodiments, a device receiving IE 200, e.g., a part of a beacon frame, may be capable of using a CW based on the values 202 and 204. For example, wireless communication unit 118 may use an initial CW having a size equal to the value 202 as defined by IE 200. Wireless communication unit 118 may select, for example, a back-off period within the CW defined by values 202 and/or 204, and wait for the back-off period prior to beginning a wireless transmission during the RATB period, e.g., as described above.

In some demonstrative embodiments, coordinator 102 (FIG. 1) may set the CWmin value 202 based on the number of current stations in the wireless area network. Additionally or alternatively, in some embodiments, coordinator 102 (FIG. 1) may set the CWmax value 204 based on the number of current stations in the wireless area network.

In some demonstrative embodiments, coordinator 102 (FIG. 1) may broadcast IE 200 including the contention-window information 203 defining a first contention window size, when the wireless area network includes a first number of stations. Coordinator 102 (FIG. 1) may broadcast IE 200 including the contention-window information 203 defining a second contention window size, which is greater than the first contention window size, when the wireless area network includes a second number of stations, which is greater than the first number. For example, coordinator 102 (FIG. 1) may broadcast IE 200 including a first value of CWmin 202, when the wireless area network includes the first number of stations; and a second value of CWmin, which is greater than the first value of CWmin 202, when the wireless area network includes the second number of stations.

In some demonstrative embodiments, coordinator 102 (FIG. 1) may adjust the contention window to include a number of slots equal to the number of stations in the wireless area network. For example, coordinator 102 (FIG. 1) may broadcast IE 200 including a value of CWmin 202, which includes a number of slots equal to the number of stations in the wireless area network.

In some embodiments, coordinator 102 (FIG. 1) may adjust the values 202 and/or 204, for example, upon receiving an association request from a station requesting to joint he wireless area network, and/or upon receiving an indication that a station has left the wireless area network. Coordinator 102 (FIG. 1) may include the adjusted values 202 and/or 204 in IE 200 as part of a successive beacon frame.

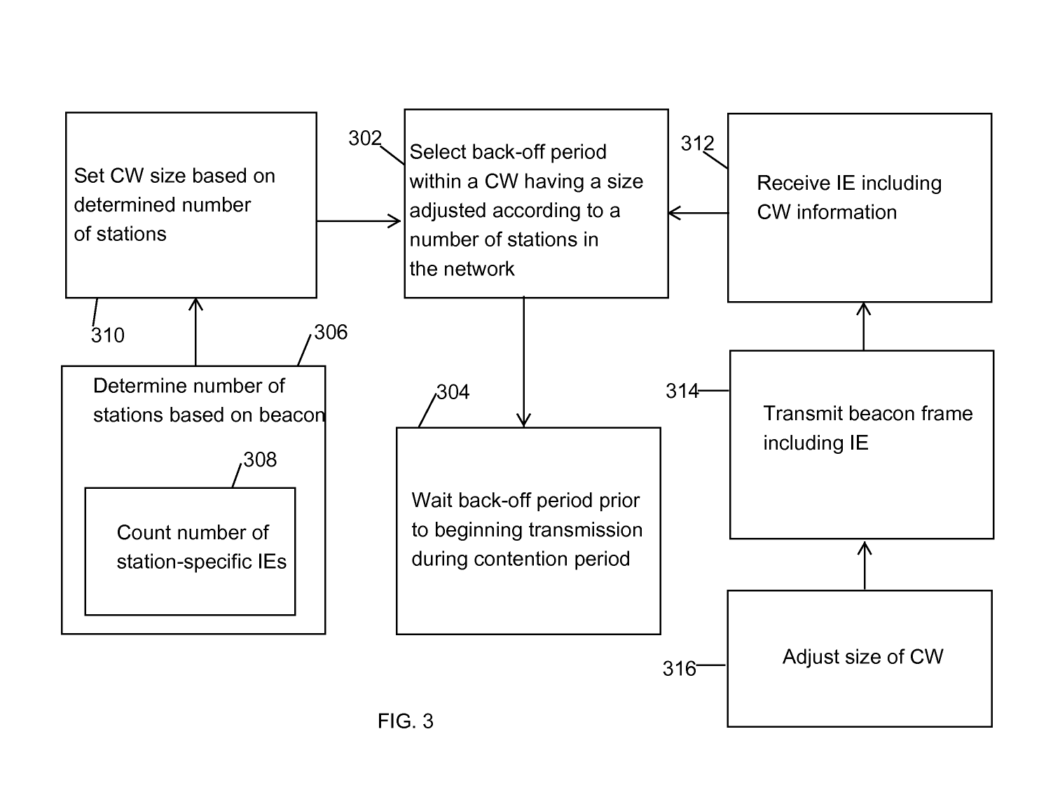

Reference is now made to FIG. 3, which schematically illustrates a method of wireless communication, in accordance with some demonstrative embodiments. In one embodiment, one or more operations of the method of FIG. 3 may be performed by system 100 (FIG. 1), wireless communication device 104 (FIG. 1), wireless communication unit 118 (FIG. 1) and/or coordinator 102 (FIG. 1).

As indicated at block 302, the method may include selecting a back-off period within a contention-window having a contention-window size, which is adjusted based on a number of stations included in a wireless area network. For example, wireless communication unit 118 (FIG. 1) may select a back-off period within a CW having a CW size, which is adjusted based on a number of stations included in the wireless area network of system 100 (FIG. 1), e.g., as described above.

As indicated at block 304, the method may include waiting for the back-off period prior to beginning a wireless transmission from the wireless station during a contention period. For example, wireless communication unit 118 (FIG. 1) may wait for the back-off period prior to beginning a wireless transmission during the RATB period, e.g., as described above.

As indicated at block 306, the method may include determining the number of stations included in the wireless area network based on a beacon frame received by the wireless station. For example, wireless communication unit 118 (FIG. 1) may implicitly determine the number of stations in the wireless area network based on the beacon frame from coordinator 102 (FIG. 1), e.g., as described above.

As indicated at block 308, the method may include determining the number of stations included in the wireless area network by counting a number of station-specific information elements included in the beacon frame, e.g., as described above.

As indicated at block 310, the method may include setting the contention window size based on the determined number of stations included in the wireless area network. For example, wireless communication unit 118 (FIG. 1) may set the CW size based on the determined number of stations, e.g., as described above.

As indicated at block 312, the method may include receiving at the wireless station an information-element including CW information, which defines the size of the contention window based on the number of stations in the wireless area network. For example, wireless communication unit 118 (FIG. 1) may receive an IE, e.g., IE 200 (FIG. 2) including CW information, e.g., CW information 203 (FIG. 2), defining the size of the CW, e.g., as described above.

As indicated at block 314, the method may include transmitting a beacon frame to the plurality of stations, wherein the beacon frame includes CW information, which defines the contention window size to be used by the plurality of stations during the contention period. For example, coordinator 102 (FIG. 1) may broadcast IE 200 (FIG. 2) to devices 104 and/or 106 (FIG. 1), e.g., as described above.

As indicated at block 316, the method may include adjusting the contention window size defined by the CW information based on the number of the plurality of stations. For example, coordinator 102 (FIG. 1) may adjust the CWmin value 202 (FIG. 2) based on the number of stations in the WVAN, e.g., as described above.

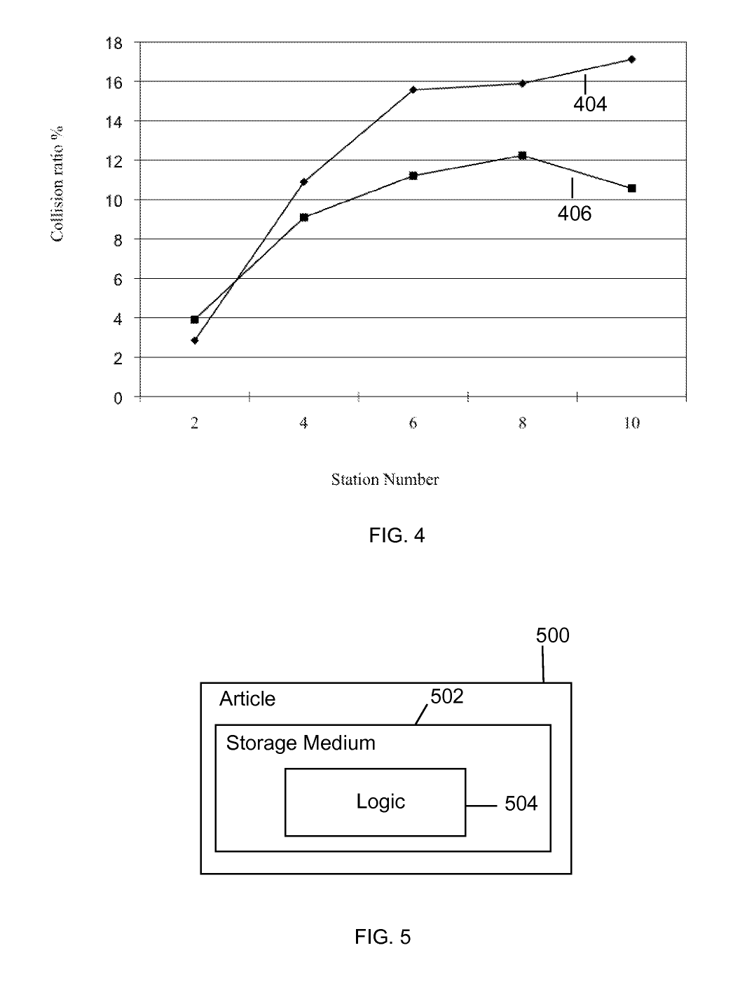

Reference is now made to FIG. 4, which schematically illustrates a first graph 404 depicting a collision probability as a function of a number of stations in the wireless area network, when using an initial contention window having a constant size of four slots; and a second graph 406 depicting a collision probability as a function of a number of stations in the wireless area network, when using a dynamic initial contention window having a number of slots adjusted according to the number of stations in the wireless area network, in accordance with some demonstrative embodiments.

A shown in FIG. 4, when the number of stations in the wireless area network is greater than three, adjusting the size of the CW based on the number of stations may result in a reduced collision probability compared to the collision probability achieved with a constant 4-slot contention window.

Reference is made to FIG. 5, which schematically illustrates an article of manufacture 500, in accordance with some demonstrative embodiments. Article 500 may include a machine-readable storage medium 502 to store logic 504, which may be used, for example, to perform at least part of the functionality of wireless communication unit 118 (FIG. 1), wireless communication unit 107 (FIG. 1) and/or wireless communication unit 109 (FIG. 1); and/or to perform one or more operations of the method of FIG. 3.

In some embodiments, article 500 and/or machine-readable storage medium 502 may include one or more types of computer-readable storage media capable of storing data, including volatile memory, non-volatile memory, removable or non-removable memory, erasable or non-erasable memory, writeable or re-writeable memory, and the like. For example, machine-readable storage medium 502 may include, random-access memory (RAM), dynamic RAM (DRAM), Double-Data-Rate DRAM (DDR-DRAM), synchronous DRAM (SDRAM), static RAM (SRAM), read-only memory (ROM), programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some embodiments, logic 504 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some embodiments, logic 504 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

Functions, operations, components and/or features described herein with reference to one or more embodiments, may be combined with, or may be utilized in combination with, one or more other functions, operations, components and/or features described herein with reference to one or more other embodiments, or vice versa.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A wireless communication device including:
a wireless communication unit to control transmissions of the wireless communication device in a wireless area network during a contention period,
wherein the wireless communication unit is to select a back-off period within a contention-window having a contention-window size, which is adjusted based on a number of stations included in the wireless area network,
and wherein the wireless communication unit is to wait for the back-off period prior to beginning a wireless transmission during the random-access-time-block.

2. The wireless communication device of claim 1, wherein the wireless communication unit is to determine the number of stations included in the wireless area network based on a beacon frame received from the wireless area network, and to set the contention window size based on the number of stations included in the wireless area network.

3. The wireless communication device of claim 2, wherein the wireless communication unit is to determine the number of stations included in the wireless area network by counting a number of station-specific information elements included in the beacon frame.

4. The wireless communication device of claim 1, wherein the wireless communication unit is to receive an information-element including contention-window information, which defines the size of the contention window based on the number of stations in the wireless area network.

5. The wireless communication device of claim 1, wherein the wireless communication unit is to select the back-off period from a contention window of a first size, when the wireless area network includes a first number of stations,
and wherein the wireless communication unit is to select the back-off period from a contention window of a second size, which is greater than the first size, when the wireless area network includes a second number of stations, which is greater than the first number.

6. The wireless communication device of claim 1, wherein the wireless communication unit is to adjust the contention window to include a number of slots equal to the number of stations in the wireless area network.

7. The wireless communication device of claim 1, wherein the wireless area network includes a wireless video area network, and wherein the contention period includes a random-access-time-block period.

8. A system including:
a wireless communication coordinator to coordinate communication between a plurality of stations in a wireless area network by transmitting a beacon frame to the plurality of stations,
wherein the beacon frame includes contention-window information, which defines a contention window size to be used by the plurality of stations during a contention period,
and wherein the wireless communication coordinator is to adjust the contention window size based on the number of the plurality of stations.

9. The system of claim 8, wherein the contention-window information defines a first contention window size, when the wireless area network includes a first number of stations, and wherein the contention-window information defines a second contention window size, which is greater than the first contention window size, when the wireless area network includes a second number of stations, which is greater than the first number.

10. The system of claim 8, wherein the wireless communication coordinator is to adjust the contention window to include a number of slots equal to the number of stations in the wireless area network.

11. The system of claim 8 including at least one station of the plurality of stations, wherein the station includes a wireless communication unit to select a back-off period within the defined contention-window and to wait for the back-off period prior to beginning a wireless transmission during the contention period.

12. The system of claim 8, wherein the wireless area network includes a wireless video area network, and wherein the contention period includes a random-access-time-block period.

13. A method including:
at a wireless station in a wireless area network, selecting a back-off period within a contention-window having a contention-window size, which is adjusted based on a number of stations included in the wireless area network; and
waiting for the back-off period prior to beginning a wireless transmission from the wireless station during a contention period.

14. The method of claim 13 including:
determining the number of stations included in the wireless area network based on a beacon frame received by the wireless station; and
setting the contention window size based on the number of stations included in the wireless area network.

15. The method of claim 14 including determining the number of stations included in the wireless area network by counting a number of station-specific information elements included in the beacon frame.

16. The method of claim 13 including receiving at the wireless station an information-element including contention-window information, which defines the size of the contention window based on the number of stations in the wireless area network.

17. The method of claim 13 including:
transmitting a beacon frame to the plurality of stations, wherein the beacon frame includes contention-window information, which defines the contention window size to be used by the plurality of stations during the random-access-time-block; and
adjusting the contention window size based on the number of the plurality of stations.

18. The method of claim 13 including:
selecting the back-off period from a contention window of a first size, when the wireless area network includes a first number of stations,
and selecting the back-off period from a contention window of a second size, which is greater than the first size, when the wireless area network includes a second number of stations, which is greater than the first number.

19. The method of claim 13 including adjusting the contention window to include a number of slots equal to the number of stations in the wireless area network.

20. The method of claim 13, wherein the wireless area network includes a wireless video area network, and wherein the contention period includes a random-access-time-block.
